(19) United States
(12) Patent Application Publication
(10) Pub. No.: US 2024/0173715 A1
(43) Pub. Date: May 30, 2024

(54) DISPOSABLE CARTRIDGE FOR PERFORMING AN AUTOMATIC SAMPLE PREPARATION

(71) Applicant: Pratimesh Labs Pvt. Ltd., New Delhi (IN)

(72) Inventors: Usama Ahmed Abbasi, Gorakhpur (IN); Prakhar Jain, Bhilai (IN); Vishwanth Kumaran, Bangalore (IN); Saikat Paul, Bangalore (IN)

(21) Appl. No.: 18/383,620

(22) Filed: Oct. 25, 2023

Related U.S. Application Data
(63) Continuation of application No. PCT/IN2019/050154, filed on Feb. 26, 2019.

(30) Foreign Application Priority Data
Feb. 27, 2018 (IN) 201811007278

(51) Int. Cl. B01L 3/00

(52) U.S. Cl. CPC B01L 3/502746; B01L 2300/048; B01L 2300/0874; B01L 2400/0487; B01L 2400/0622

(57) ABSTRACT

A disposable cartridge for performing an automatic sample preparation, said cartridge comprising: a barrel housing layer (L2) to host extruded barrels for housing liquids (reagents), each barrel being a piston actuated barrel sealed with a frangible seal, said barrel housing layer receiving and storing a blood sample to be tested; a puncturing layer (L4) to host needles in order to puncture said frangible seal upon receiving a force from its operative bottom side; a liquid flow channel layer (L5) with liquid flow channels and valves, for providing micro-channels for splitting, routing, and metering of said samples with reagents; a soft membrane (L6) to work as an interface for mixing liquids and for blocking fluidic channels to prevent flow of fluids in channels of choice; and an actuation layer (L8) to provide actuation force for closing or opening of said valves.

### RELATED APPLICATIONS

This application claims the benefit under 35 U.S.C. § 120, and is a continuation, of co-pending International Application PCT/IN2019/050154, filed Feb. 26, 2019 and designating the US, which claims priority to IN Application 201811007278, filed Feb. 27, 2018, such IN Application also being claimed priority to under 35 U.S.C. § 119. These IN and International applications are incorporated by reference herein in their entireties.

### FIELD

This invention relates to the field of biomedical engineering.

Particularly, this invention relates to a disposable cartridge for performing an automatic sample preparation.

More particularly, this invention relates to a disposable cartridge with pre-loaded reagents for performing series of fluidic operations including metering, mixing, splitting, routing, and dilution of sample with reagents.

More particularly, this invention relates to a multilayer disposable cartridge for performing an automatic sample preparation which can carry out a series of fluidic operations such as mixing, metering, splitting, dilution, and routing of fluids needed for sample preparation.

### BACKGROUND

Samples, for examples, blood, urine etc. are collected in the small vials or test tubes for use for conducting different kinds of tests. But, nowadays, samples are collected in a microfluidic device which need surface treatment to enhance hydrophilicity of the material which is an extra step added in microfluidic device fabrication. Also, a hydrophobic coating is needed in such devices to stop the sample from filling in a particular microfluidic channel while collecting a sample, from a user, for precision metering of small volume of sample with reagents and also requires a rotary valve for metering an accurate sample in a fluidic channel with reagents.

In European patent application EP 2842628, a hydrophobic valve for metering small amount of blood using a rotary valve is disclosed.

A disposable device called as mili-fluidics cartridge is disclosed by Chempaq in US patent application no. US20060177347. This device performs metering of samples with reagents using a rotary valve. One disadvantage of the rotary valve is that it requires precision alignment with the microfluidic channel to ensure leak-proof flow especially when it is more than 3 way direction and also the fabrication of the valve is difficult and costly especially for the poor-resource settings.

The microfluidic channel needs accurate metering of the samples with reagents, which can be carried out using rotary valve or pneumatically driven fluidic channel for opening and closing of the channel. A device comprising a pneumatically controlled valve mechanism capable of sustaining few kilopascal pressures before leaking is disclosed in US patent application no. US20130032235. However, the disadvantage with pneumatically controlled valves is that sample preparation is not rapid and throughput is very low.

One other section of a microfluidic device needs mixing of sample with the reagents inside the channel. US patent application no. US20130320999 discloses a method for performing mixing inside a microfluidic channel using long serpentine channel; the disadvantage of which is a huge pressure drop. The mixing according to this patent application is due to molecular diffusion, which is a slow process. The reagents were not stored on the microfluidic cartridge but were stored in a bottle connected to the chip by a fluidic channel and it was driven using a pressure pump; the disadvantage of which is a creation of a bubble inside the channel.

US 20060183216 discloses a patent for reagent storage on a microfluidic cartridge but the disadvantage is that it adds extra dead volume on to the cartridge and is not suitable for reagents where volume requirement is less than 100 μL.

### SUMMARY

It is thus observed that though some disposable devices are, as such, known in prior art, there are disadvantages associated with each of the devices known in the prior art and which are discussed, herein, above.

Therefore, there is a need to develop/invent a disposable device/cartridge wherein the disadvantages associated with the prior art have been avoided.

Therefore an object of the present invention is to provide a disposable cartridge for performing an automatic sample preparation and which obviates the disadvantages associated with the prior art.

Another object of the present invention is to provide a disposable cartridge for performing an automatic sample preparation wherein hydrophobic coating is not needed to stop the sample from filling in a particular microfluidic channel.

Yet another object of the present invention is to provide a disposable cartridge for performing an automatic sample preparation wherein no rotary valve is required for metering the accurate sample in the fluidic channel with the reagents.

Still another object of the present invention is to provide a disposable cartridge for performing an automatic sample preparation wherein no precision alignment with the microfluidic channel is required to ensure leak-proof flow especially when it is more than a 3 way direction.

A further object of the present invention is to provide a disposable cartridge for performing an automatic sample preparation wherein pneumatically controlled valve is not needed and therefore the sample preparation is rapid and the throughput is high.

A further object of the present invention is to provide a disposable cartridge for performing an automatic sample preparation wherein reagents are stored in an inbuilt microfluidic cartridge and therefore creation of bubble inside the channel is avoided.

According to this invention, there is provided a disposable cartridge for performing an automatic sample preparation, said cartridge comprising:
at least a barrel housing layer configured to host extruded barrels for housing liquids (reagents), each barrel being a piston actuated barrel sealed with a frangible seal from its operative bottom side, said barrel housing layer further configured to receive and store a blood sample of a user, which blood sample is to be tested;
at least a puncturing layer configured to host needles in order to puncture said frangible seal of at least one of said barrels for ejecting liquid out of said barrel, each of said needles corresponding with a barrel, upon receiving a force from its operative bottom side;
at least a liquid flow channel layer configured with liquid flow channels and valves, built therein, for providing micro-channels for splitting, routing, and metering of said samples with reagents housed in said barrels based on pre-determined opening and closing of sets of valves to determine an appropriate channel path for flow;
at least a soft membrane configured to work as an interface and is useful for mixing liquids which have a low Renaults number, said soft membrane being configured for in blocking fluidic channels to prevent flow of fluids in channels of choice by closing and opening of said valves; and
at least an actuation layer configured to provide actuation force for closing or opening of said valves.

Typically, said cartridge is configured to provide at least two different sample preparation processes, simultaneously, by splitting the sample between a first set of valves and a second set of valves.

Typically, said cartridge is configured to provide at least two different sample preparation processes, simultaneously, by splitting the sample between a first set of valves and a second set of valves, in that said first set of valves being opened for WBCs enumeration.

Typically, said cartridge is configured to provide at least two different sample preparation processes, simultaneously, by splitting the sample between a first set of valves and a second set of valves, in that second set of valves being opened for RBCs enumeration and platelet enumeration.

Typically, said cartridge comprises at least a top layer for covering said barrels from the side.

Typically, said cartridge comprises at least a bottom layer for encasing said layers to protect it from human-intervention.

Typically, said cartridge comprises at least a first pressure-sensitive adhesive layer configured to join said barrel housing layer to said puncturing layer.

Typically, said cartridge comprises at least a second pressure-sensitive adhesive layer configured to join said soft membrane to said actuation layer.

Typically, said actuation layer comprises:
pillars for closing valves, said pillar extruding from pre-defined positions of base of said actuation layer, each pillar corresponding, in position, with at least a valve of said liquid flow channel layer; and
spring loaded clamps configured to displace said actuation layer towards or away from said liquid flow channel layer based through said soft membrane.

Typically, said cartridge comprises at least a permanent valve built inside said cartridge which can sustain more than 100 kPa of pressure required for opening a valve for metering of samples with reagents.

Typically, said barrel housing layer comprises piston-operated barrels, in that, linear actuators are configured to actuate corresponding pistons for corresponding barrels in order to enable flushing out of fluid (samples) at constant volumetric flow rate.

Typically, said barrel housing layer comprises a plurality of mixing barrels for facilitating mixing of a sample as and when required, characterised in that, said mixing barrels having a side vent in order to vent out air.

Typically, said barrel housing layer comprises at least a waste collection barrel to collect waste generated after conducting a required test.

Typically, said barrel housing layer comprises at least a suction chamber to collect and send blood sample straight into a microfluidic channel of said liquid flow channel layer.

Typically, said barrel housing layer comprises at least mixing barrels and pre-loaded reagent barrels, characterised in that, the centre of said mixing barrels and said preloaded reagent barrels being arranged on vertices of a regular n-sided polygon to give rotation symmetry of more than four.

Typically, said barrel housing layer comprises at least mixing barrels and pre-loaded reagent barrels, characterised in that, the centre of said mixing barrels and said preloaded reagent barrels being kept on vertices of a regular pentagon and a hexagon to give 5 degree of rotational symmetry for WBCs sample preparation and 6 degree of rotational symmetry for RBCs sample preparation in order to push and mix the reagents and samples multiple times only with a two stepper motor and two linear actuators.

Typically, said barrel housing layer comprises a blood inlet port which is connected to a suction chamber by a straight microfluidic channel and several microfluidic side channels, characterised in that, said barrel housing layer comprising a membrane located above said blood inlet port for creating a negative pressure inside said channel.

Typically, said cartridge comprises vias made below said soft membrane in order to store blood samples so that sample volume can be increased.

### BRIEF DESCRIPTION OF THE DRAWINGS

The invention will now be described in relation to the accompanying drawings, in which:

FIG. 1 illustrates all the layers (L1, L2, L3, L4, L5, L6, L7, L8, L9) of this disposable cartridge;

FIG. 2 is an isometric view of the second layer (L2) of the cartridge;

FIG. 3 is a side view of the microfluidic cartridge while sample collection;

FIG. 4 is a side view of the microfluidic cartridge after sample collection

FIG. 5 illustrates permanent closing of side channels by pressing the soft membrane through spring loaded pillars;

FIG. 6 illustrates layer L4 having needle;

FIG. 7 shows a thin layer L5 of having microfluidic channel;

FIG. 8 shows a thin layer L5 of having microfluidic channel wherein it shows side valves are opened for splitting of sample;

FIG. 8A shows combination of valves for sample preparation for both RBCs and platelet and WBCs in the same cartridge including hemoglobin measurement collected in a waste chamber;

FIG. 9 shows a thin layer L5 of having microfluidic channel wherein it shows all valve positions that can be opened and closed using linear actuators;

FIG. 10 illustrates that sample between valve 30 and valve 31 can be used for WBCs enumeration and the sample between valve 32 and valve 33 can be used for RBCs and platelet enumeration;

FIG. 11 shows spring loaded fixture of Layer L8;

FIG. 12 shows rupturing of foil L6 causing reagents to release from holes;

FIG. 13 illustrates layer L2 and layer L9; and

FIG. 14 illustrates layer L7 clamped on the layer L9 though clamps.

### DETAILED DESCRIPTION

According to this invention there is provided a disposable cartridge for performing an automatic sample preparation. This invention relates to a sample collection inside the disposable cartridge which avoids surface treatment to enhance hydrophilicity of the material and also carry out a series of fluidic operations for implementing automatic sample preparation. The hydrophobic coating is required to stop the sample from filling in a particular microfluidic channel while collecting a sample, from a user, for precision metering of small volume of blood.

The present invention also describes an art of fabricating a valve using a soft flexible membrane of shore hardness from 20 A to 35 A for collecting a precision amount of blood sample and also an accurate metering of blood samples with various reagents for automatic sample preparation inside the disposable cartridge of this invention. The disposable microfluidic cartridge is capable of sample preparation for both RBCs and platelet and WBCs in the same cartridge including hemoglobin measurement collected in a waste chamber.

The present invention also describes a permanent valve already built inside the cartridge which can sustain more than 100 kPa of pressure required for opening the valve for metering of sample with reagents. The permanent valve is better than a hydrophobic valve because the burst pressure required in hydrophobic valve is less than a few hundred Pascal. The initial status of the permanent valve is a closed position which prevents fluid from entering into certain sections.

The fabrication of this cartridge includes a barrel with preloaded reagents sealed either using blister package or a rubber piston to prevent any contamination or leakage especially during the transportation of the cartridge. The cartridge also has a wash buffer preferably DI water for cleaning of a bio-sensor already integrated with a reader which may not be a part of the cartridge. The cartridge has more than two sections or at least two sections where two different sample preparations can be done requiring dilution, mixing, metering, routing, or splitting of fluid. Fabrication of the valve for metering is a challenge especially for the samples which require high dilution more than 10,000; the reason being high concentration of cells in 1 μL of sample. To ensure that only single cells pass between the bio-sensor dilution more than 10,000 may be required. The fluid is driven by positive displacement pump for better control of flow rate and to avoid any air bubble rather than a vacuum pump and all the valves in the cartridge, of this invention, is driven by a linear actuator unlike a pneumatic valve which can sustain only few kPa for preventing the leakage.

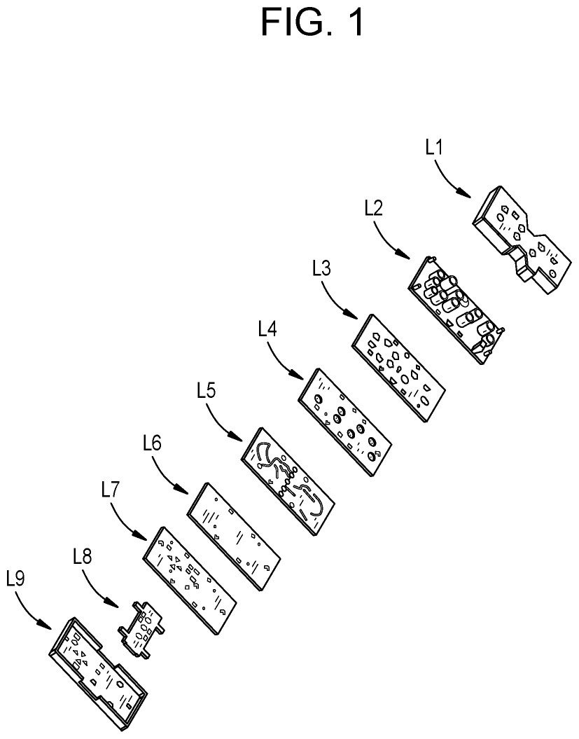

FIG. 1 illustrates all the layers (L1, L2, L3, L4, L5, L6, L7, L8, L9) of this disposable cartridge.

The cartridge is fabricated by stacking multiple layers including packaging of pre-loaded reagents on the cartridge. The top layer of the cartridge which is covered is to prevent any contamination from a side vent. The top layer of the cartridge has a barrel with pre-loaded reagents and also with empty barrels where the mixing takes place by triggering the instability at low Reynolds number and also by bubbling air through a diaphragm pump connected to a biosensor to ensure rapid mixing inside the cartridge. The architecture can be used for mixing samples and reagents inside the barrels requiring high dilution. The number of mixing steps can be increased depending on complexities of sample preparation.

L1 refers to a top-layer for covering the barrels from the side.

L2 refers to a layer which hosts barrels for housing liquid reservoirs.

L3 refers to a pressure-sensitive adhesive layer to join layer L2 to layer L4.

This is for routing the blood sample from the main channel to the thin-sheet for collecting 10 μl of blood needed for leukocytes count and then bringing it back to the main channel.

L4 refers to a layer which hosts needles which depress a membrane on one of the layers (layer L4) in order to puncture and eject liquid from the liquid reservoirs of layer L4. Essentially, it is a thin-sheet for collecting 10 micro-litres of blood needed for leukocyte count.

L5 refers to a layer with liquid flow channels built therein. Essentially, it provides the main micro-channel for splitting, routing, and metering of the samples and the reagent.

L6 refers to a soft membrane as an interface and is useful for mixing liquids which have a low Renault number. This soft flexible membrane is needed for closing and opening of valves. Essentially, this layer plays a very important role in blocking fluidic channels to prevent flow of fluids in channels of choice.

L7 refers to a pressure sensitive adhesive layer with adhesive on both sides in order to join layer L6 to layer L8.

L8 refers to a layer which hosts spring loaded clamps. Essentially, it is a fixture with pillars for closing valves.

L9 refers to a bottom cover or an encasing for covering a permanent valve to protect it from human-intervention.

In at least an embodiment, the cartridge comprises a top layer (L1) and a bottom layer (L9) having multiple layers (L2, L3, L4, L5, L6, L7, L8) provided between the top and bottom layers.

In at least an embodiment, the microfluidic cartridge comprises a second layer (L2) which hosts barrels for housing liquid reservoirs.

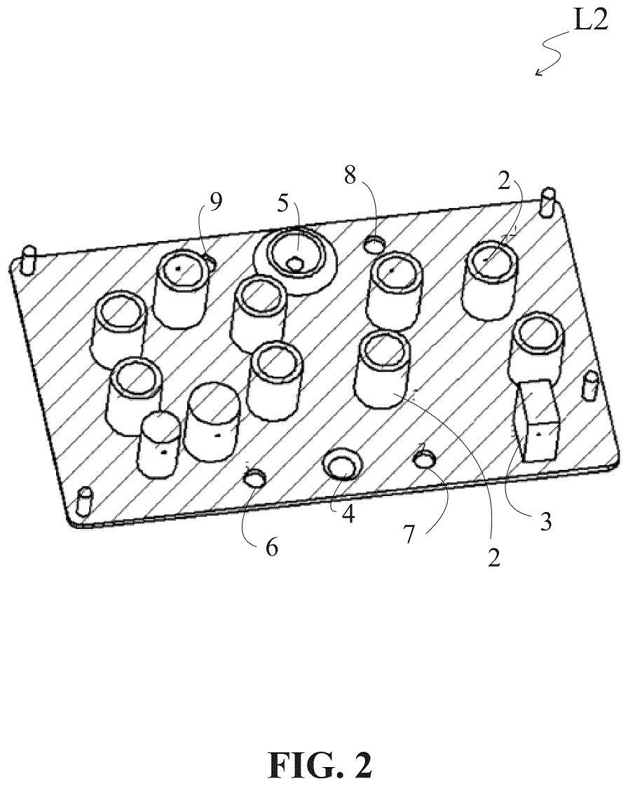

FIG. 2 is an isometric view of the second layer (L2) of the cartridge with:

| Reference | |
|---|---|
| numeral | Part/Component/Element/Member |
| 1 | Barrel with pre-loaded first reagent |
| 2 | Hole inside the mixing Barrels for venting out the air |
| 3 | Waste chamber |
| 4 | Blood inlet port |
| 5 | Suction Cavity |
| 6 | Hole for arresting a spring loaded rod from layer L8 |
| 7 | Hole for arresting a spring loaded rod from layer L8 |
| 8 | Hole for arresting a spring loaded rod from layer L8 |
| 9 | Hole for arresting a spring loaded rod from layer L8 |

In at least an embodiment, a plurality of barrels is provided where fluid (samples) are stored. Additionally, a plurality of reagent barrels (1) is provided on a layer of the microfluidic cartridge for storing pre-loaded reagents, therein. Each of these barrels are piston-operated barrels, in that, linear actuators are configured to actuate corresponding pistons for corresponding barrels in order to enable flushing out of fluid (samples) at constant volumetric flow rate. A plurality of mixing barrels (2) is provided for facilitating mixing of a sample, for example blood sample, as and when required. Typically, mixing barrels (2) have holes in order to vent out air. A waste collection barrel (3) is provided within the cartridge so as to collect waste generated after conducting a required test. The mixing barrel has a side vent for venting out the air. In at least an embodiment, a suction chamber (5) is provided to collect the sample straight into a microfluidic channel (of fifth layer i.e. L5). The reagents inside the barrels are pushed and then collected inside the mixing barrels where mixing is due to triggering of instability at low Reynolds number because of a soft flexible membrane (layer L6) as one of the microfluidic layers and by bubbling of air through a diaphragm pump which is interfaced with the microfluidic cartridge.

The cartridge, of this invention, can be used for CBC using twelve barrels; out of which three barrels are for waste collection, seven barrels are needed for RBCs and platelet enumeration, five barrels are needed for WBCs enumeration, two wastes barrels for RBCs and platelet enumeration, and one waste chamber for WBCs enumeration.

The centre of the mixing barrels and the preloaded reagent barrels are arranged on vertices of a regular n-sided polygon to give rotation symmetry of more than four. The centre of the barrels are kept on vertices of regular pentagon and hexagon to give 5 degree of rotational symmetry for WBCs sample preparation and 6 degree of rotational symmetry for RBCs sample preparation in order to push and mix the reagents and samples multiple times only with two stepper motor and two linear actuator. This is required so that the sample preparation can take place using only two stepper motor and two linear actuators where more than two different sample preparation are required. The degree of rotational symmetry can be extended depending upon the number of reagents required for sample preparation. The side of the barrel has a vent at height of about 6 mm for pushing out air.

The disposable microfluidic cartridge, of this invention, with pre-loaded reagents can perform an automatic sample preparation, at point-of-care, that needs mixing, metering, splitting, routing, and dilution of samples with reagents. The releasing of reagents takes place by rupturing a (aluminum) foil by fluidic pressure. The present invention can be applied to a variety of applications such as automatic sample preparation needed for CBC at point-of-care or CD4 T cells counting or detection of various antigen present inside the sample. The present invention provides control structure for implementing dilution of samples, sample collection, metering, mixing, routing, and splitting of fluid as needed for sample preparation.

For example, in FIG. 2, the right half-side barrels can be used for enumeration of WBCs requiring two different reagents and the left half-side can be used for the enumeration of RBCs along with platelet requiring high dilution of more than 10,000 of blood sample. The high dilution requires metering of samples in two steps; in the first step of dilution, sample the dilution can be 100 times and in the second step of dilution, the first diluted sample can further be diluted to 100 times to obtain a second diluted sample.

In one embodiment, the sample is collected inside the microfluidic channel either from a finger prick or from venous blood. The blood from the finger prick is kept at a blood inlet port (4) which is connected to the suction chamber (5) by a straight microfluidic channel and several microfluidic side channels having inbuilt permanent valves with solid pillars which are spring loaded pressing the soft elastomer from behind and blocking the channel of height ranging from 50-100 micron. There is also provided a membrane located above the blood inlet port (4) for creating a negative pressure inside the channel.

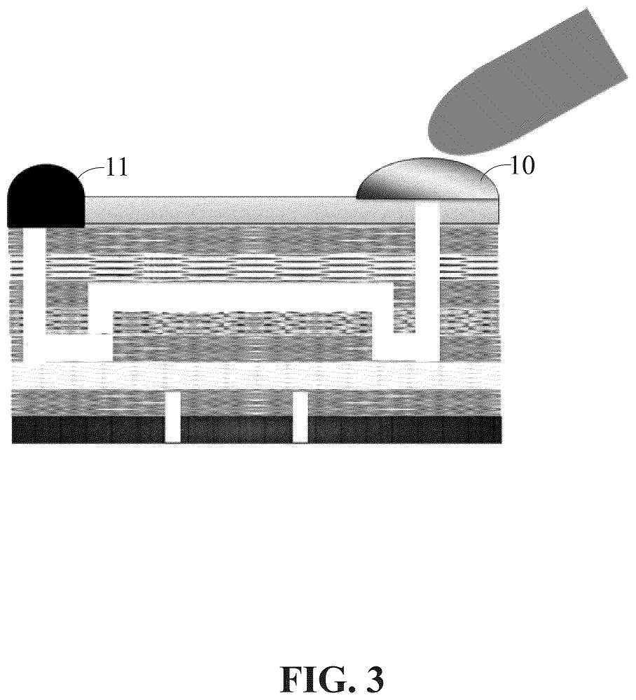

The present invention describes a state-of-the art technology for fabricating a microfluidic disposable cartridge with inbuilt permanent valve different from a hydrophobic valve that stops the blood flow in certain section of the microfluidic channel while collecting blood from a patient either from finger prick or venous-punctured blood for precision metering of the sample and the reagents needed for automatic sample preparation. In order to avoid any capillary valve action, arising due to sudden expansion of the channel, the blood is collected by pressing the soft membrane, creating a negative pressure inside the cartridge and then releasing the membrane just like a pipette action based on vacuum suction shown in FIG. 3. This ensures that blood will not stop inside the micro-channel due to sudden expansion either in the Z-direction or in X-Y direction and also avoids any extra step needed for hydrophilic coating needed to enhance the capillary action. The cartridge has many layers of which one layer, a fixture with four pillars preferably of height 5 mm which sits tightly beneath the cartridge pressing the soft membrane from behind and closing the channel to prevent any flow inside the side channels unless actuated by a linear actuator having sufficient force to deflect it. The force on the flexible membrane is exerted by four pillars which is actuated by four springs closing the valve permanently.

FIG. 3 is a side view of the microfluidic cartridge while sample collection:

| Reference | |
|---|---|
| numeral | Part/Component/Element/Member |
| 10 | Membrane for creating a suction inside the microfluidic |
| | cartridge |
| 11 | Sample for collection |

FIG. 3 shows a clear side view where the membrane (10) is first pressed to create suction and then a blood sample (11) is drawn from a patient's finger in order to avoid any air bubble. This membrane is provided above the suction chamber (5) for creating a negative pressure inside the channel. The volume of the suction chamber (5) has a lower volume compared to the volume of blood inlet port (4) in order to ensure that very little blood is drawn inside the suction chamber (5) and then to metering chamber.

In at least an embodiment, the microfluidic cartridge comprises a third layer (L3) which is a pressure-sensitive adhesive layer to join layer L2 to layer L4. This is for routing the blood sample from the main channel to the thin-sheet plastic for collecting 10 μl of blood needed for leukocytes count and then bringing it back to the main channel.

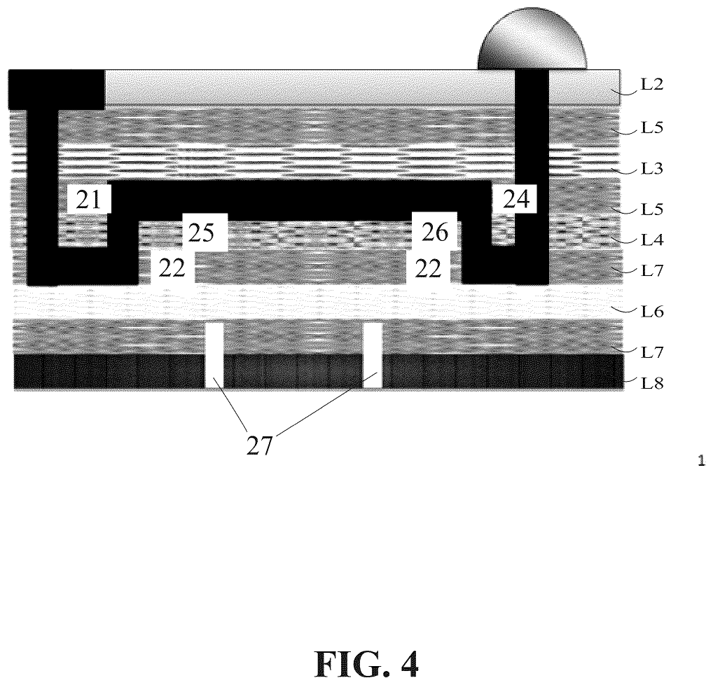

FIG. 4 is a side view of the microfluidic cartridge after sample collection:

| Reference | |
|---|---|
| numeral | Part/Component/Element/Member |
| L2 | The top layer of the cartridge having barrels |
| L5 | Microfluidic channel made in thin sheet |
| L3 | Thin aluminum foil for reagent sealing |
| L5 | Microfluidic channel made in thin sheet |
| L4 | Thin sheet with sharp needle for rupturing of aluminum foil. |
| L5 | Microfluidic channel where metering, mixing, splitting take |
| | place |
| L6 | Soft flexible membrane |
| L7 | Thin sheet for bonding soft layer with plastic |
| L7 | Thin sheet with holes for deflecting membrane with linear |
| | actuators |
| 21 | Via made in L5 |
| 22 | Via made in L7 |
| 23 | Via made in L7 |
| 24 | Via made in L5 |
| 25 | Via made in L6 |
| 26 | Via made in L6 |

In at least an embodiment, vias (21, 22, 23, 24, 25, 26) are made below the soft layer in order to store samples so that sample volume can be increased. Reference numeral 27 refers to pathways which receive spring clamps (or linear actuators) (28) from one of the lower layers.

In at least an embodiment, the microfluidic cartridge comprises a fourth layer (L4) which is a layer which hosts needles which depress a membrane on one of the layers in order to puncture and eject liquid from the liquid reservoirs. Essentially, it is a thin-sheet plastic for collecting 10 micro-liter of blood needed for leukocyte count.

Layer L4 is a thin sheet with needles for rupturing of the layer L2. There are provided vias 21, 22, 23, 24, 25, 26 in layer L5, L6, and L7. The sample is first introduced in suction chamber (5) where, after creating suction, by pressing membrane (10), the sample travels from layer L2 to layer L3, L4, L5, L6, and L7. There are provided holes in layer L7 for sample collection which can be more than two depending on the number of different sample preparation required. The diameter of the holes in layer L6 of thickness more than 2 mm is more than 3 mm for collecting sample of volume 14 μl.

Several microfluidic side channels are provided having inbuilt permanent valves (37, 38, 39, 40) with solid pillars (42, 43, 44, 45) which are spring loaded and by pressing the soft elastomer (L6) from underneath and blocking the channel of height ranging from 50-100 micron.

In at least an embodiment, the microfluidic cartridge comprises a fifth layer (L5) which is a layer with liquid flow channels built therein. Essentially, it provides the main micro-channel for splitting, routing and metering of the samples and the reagent.

Layer L5 is a thin sheet with microfluidic channels having thickness from 50 μm-100 μm for sample collection.

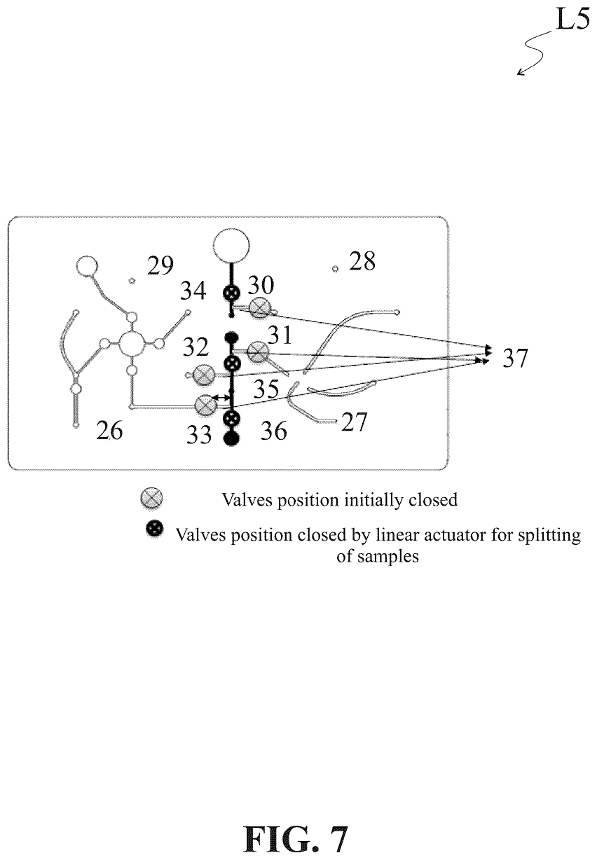

FIG. 7 shows a thin layer L5 of having microfluidic channel wherein the side channels are closed by the four pillars to prevent the flow of samples inside the side channel:

| Reference | |
|---|---|
| numeral | Part/Component/Element/Member |
| 26 | Via made in layer L5 for bio-interface |
| 27 | Via made in layer L5 for bio-sensor interface |
| 28 | Via made in layer L5 for washing bio-sensor |
| 29 | Via made in layer L5 for washing bio-sensor |
| 30 | Holes for permanent valve |
| 31 | Holes for permanent valve |
| 32 | Holes for permanent valve |
| 33 | Holes for permanent valve |
| 34 | Holes for linear actuator |
| 35 | Holes for linear actuator |
| 36 | Holes for linear actuator |

For use of this cartridge, it is placed or loaded on to a machine. This machine has linear actuators (28) which are received at appropriate location in the cartridge so that blood samples can be tested. The linear actuators (28) open and close valves of the cartridge.

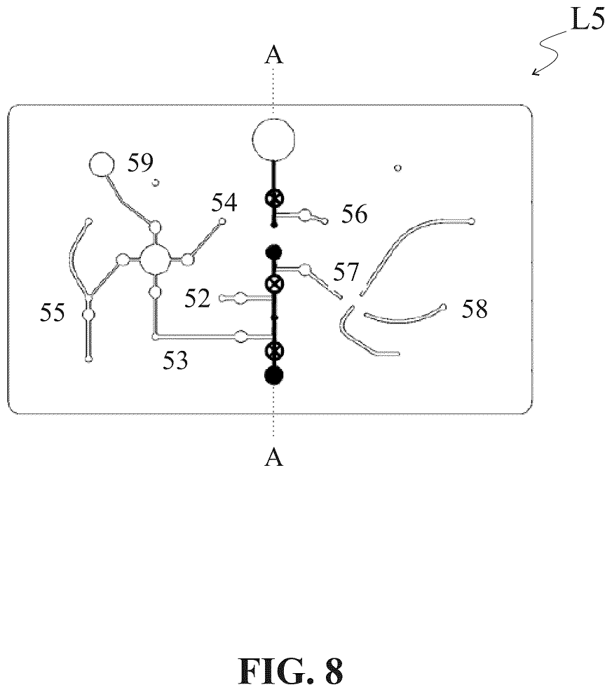

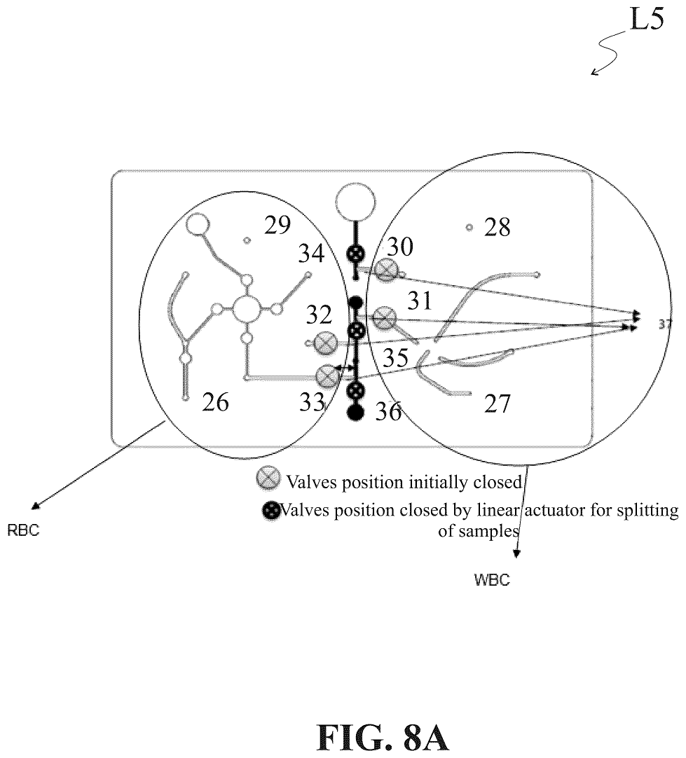

FIG. 8 shows a thin layer L5 of having microfluidic channel wherein it shows side valves are opened for splitting of sample.

Reference numeral 52, 53, 59 refer to barrel positions. Reference numeral 54, 56, 57, 58 refer to barrels. Reference numeral 55 refers to an exit portion of the cartridge for pushing out the fluid out of cartridge to a sensor. In at least an exemplary embodiment, upon actuation of a piston of barrel 52, sample is pushed in barrel 53 and upon actuation of a piston of barrel 53, sample is pushed in barrel 54.

FIG. 8A shows combination of valves for sample preparation for both RBCs and platelet and WBCs in the same cartridge including hemoglobin measurement collected in a waste chamber.

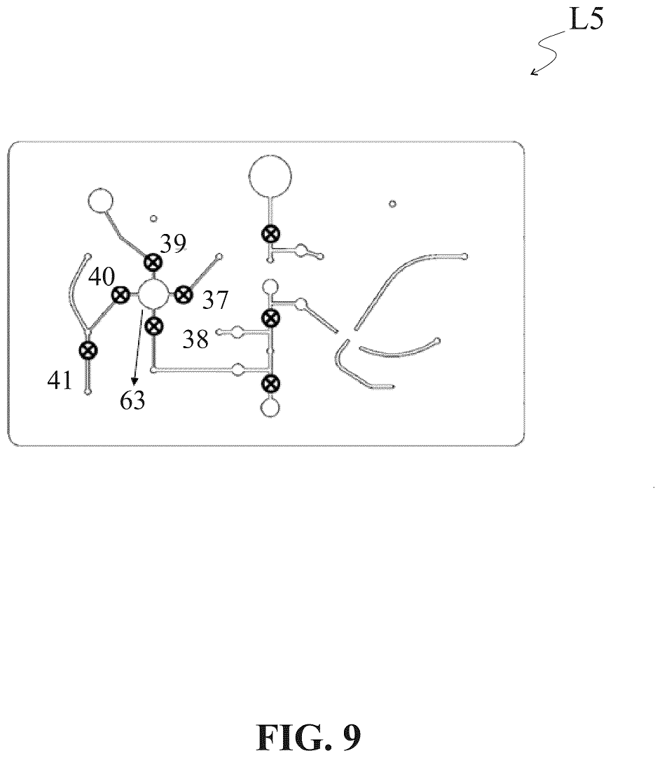

FIG. 9 shows a thin layer L5 of having microfluidic channel wherein it shows all valve positions that can be opened and closed using linear actuators:

| Reference | |
|---|---|
| numeral | Part/Component/Element/Member |
| 37 | Valves required for metering of samples and reagents. The |
| | metering of the samples may be required for high dilution of |
| | samples |
| 38 | Valves required for metering of samples and reagents. The |
| | metering of the samples may be required for high dilution of |
| | samples |
| 39 | Valves required for metering of samples and reagents. The |
| | metering of the samples may be required for high dilution of |
| | samples |
| 40 | Valves required for metering of samples and reagents. The |
| | metering of the samples may be required for high dilution of |
| | samples |
| 41 | Small fluid chamber required for further dilution or mixing |
| | with other sample |
| 52 | Position of the barrels |
| 53 | Position of the barrels |
| 54 | Position of the barrels |
| 55 | Position of the barrels |
| 56 | Position of the barrels |
| 57 | Position of the barrels |
| 58 | Position of the barrels |
| 59 | Position of the barrels |
| 60 | needle made which is the integral part of the thin plastic |
| | sheet for rupturing the aluminum foil |
| 61 | piston of the barrel |
| 62 | holes for releasing the reagent |
| 63 | Pneumatic valves |
| 64 | Pneumatic valves |
| 65 | Pneumatic valves |
| 66 | Pneumatic valves |
| 67 | Membrane pump for blowing air inside the mixing barrels |
| 68 | Membrane pump for blowing air inside the mixing barrels |
| 69 | Side view of the fixture |
| 71 | Clamp of the outer covering |
| 72 | Outer covering of the barrels |
| 73 | Membrane pump for blowing air inside the barrel for mixing |
| | of sample and the reagent |
| 74 | Membrane pump for blowing air inside the barrel for mixing |
| | of sample and the reagent |

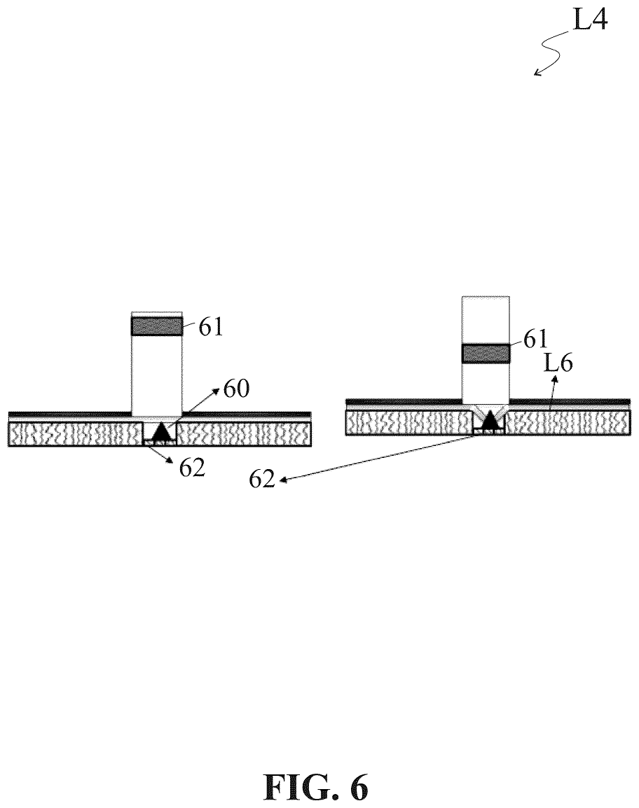

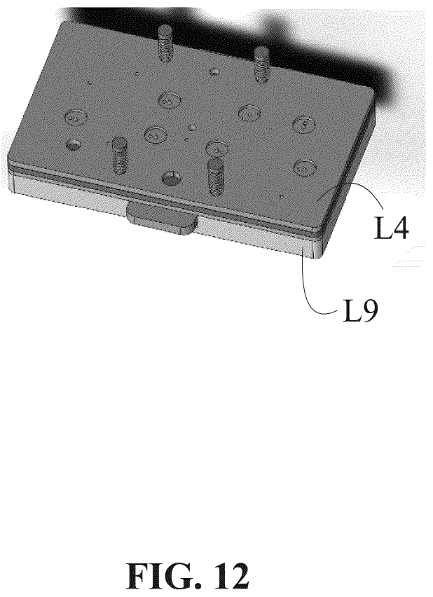

The pre-loaded reagents, at pre-defined positions (52, 54, 56, 58), as seen in FIG. 8, in layer L5, are sealed from underneath with a frangible seal. Typically, this frangible seal is a (aluminum) foil (layer L6). Pressure is applied at the piston of pre-loaded reagents which exerts a fluidic pressure on the foil (layer L6). The foil (layer L6) is bonded with a (plastic) layer (layer L7) have small sharp needles which rupture the foil (layer L6) after pressure is applied on the piston of the pre-loaded reagents. These needles do not move. Since each barrel is a piston-loaded barrel, when the piston (61) is actuated in the barrel from its operative top side, pressure in the barrel increases and the liquid in the barrel moves the frangible seal towards the needle so that the seal breaks. The layer L4 having needle (60), as seen in FIG. 6 and FIG. 12, ruptures the foil (L6) causing the reagents to release from holes (62). If there is no seal, these samples or reagents will evaporate. The pre-loaded reagents inside the barrel at location (52) are pushed to location (53) along with the sample of volume ranging from 0.5 μL to 15 μL, sweeping the sample and the reagent from valves (32 to 33).

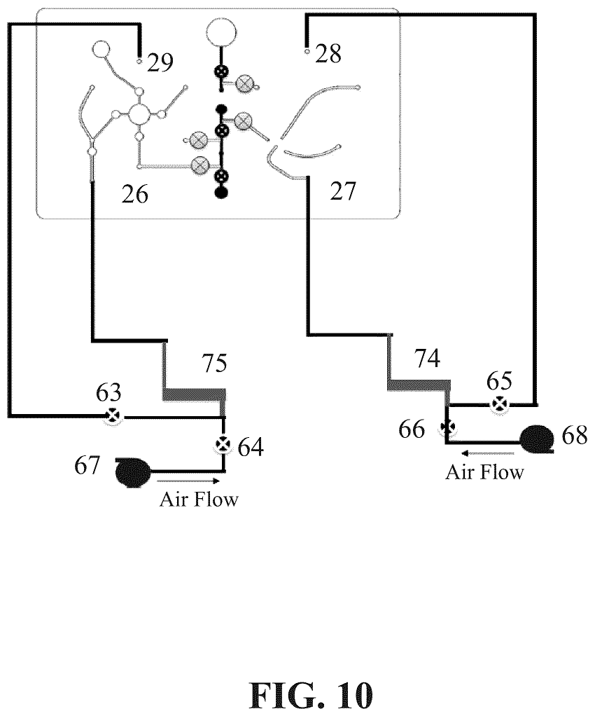

More than two different sample preparation processes can be achieved inside the cartridge by splitting the sample between (30, 31) and (32, 33). For example, as shown in FIG. 10, the sample between valve 30 and valve 31 can be used for WBCs enumeration and the sample between valve 32 and valve 33 can be used for RBCs and platelet enumeration. The two different sample preparation inside the cartridge can be performed requiring mixing, splitting, metering of fluid in parallel. The holes (26, 27, 28, 29) are made in layers (L7, L8) which is connected to a diaphragm pump joined to the sensor with pneumatic valves for blowing air inside the microfluidic cartridge for mixing of reagents and the samples. The bio-sensor (69 and 70) is connected with the microfluidic cartridge and with the diaphragm pump (67 and 68). The pneumatic valves (63 and 65) are first closed to blow the air and then the pneumatic valves (64 and 66) are closed. The fluid from the barrels (55 and 57) are pushed inside the sensor (69 and 70) and then collected in the waste chamber.

In at least an embodiment, the microfluidic cartridge comprises a sixth layer (L6) which is a soft membrane as an interface and is useful for mixing liquids with a low Renault number. This soft flexible membrane is needed for closing and opening of valves. Layer L6 is a soft flexible membrane which forms a microfluidic bottom wall of microchannel L7. The soft flexible membrane can be pressed from below through holes in layer L8 by an actuator 28 forcing it to bend inward for blocking of microfluidic channel L7.

The flexible soft membrane used in the present invention serves the following purposes:

1. It can be used as a valve for metering of blood samples and the reagents. It can be used as a flexible valve for blocking of the microfluidic channel L7 wherever needed.

2. Low pressure drop inside the microfluidic channel L7 compare to the hard channel of same dimension. It lower down the pressure drop compare to the hard channel thus require small linear actuators for easy pushing of the fluids.

3. Triggering of instability at low Reynolds number making the flow turbulent which is required for better mixing. At higher Reynolds number (Re)>300 the flow is turbulent given that the shore hardness is less than 25 A. The order of mixing is O (6) time greater than the molecular diffusion mixing [4] inside the soft flexible channel.

In at least an embodiment, the microfluidic cartridge comprises a seventh layer (L7) which is a layer which houses support for clamps of another layer L8 and is useful in blocking channels of layer L5 so that liquid does not spill over. Essentially, it is a layer which with holes for opening and closing of valves.

The valve located at position (38) is first closed before pushing the reagents inside the barrel (52). The sample and the reagents are mixed by triggering the instability inside the microfluidic channel made of soft flexible membrane (layer L6) and after the sample and reagents are collected inside the location (53), the valves (38) are opened. Diaphragm pumps (67, 68) are connected with the corresponding holes (26, 27) which causes air to flow into the barrel (53) resulting in rigorous mixing of sample with reagents. These pumps are part of the machine onto which the cartridge, of this invention, is loaded. The valves (37 and 40) are closed and the valves (38 and 39) are opened. Closing of valves is important since it disallows air to enter during suction of blood for precise metering. The mixed sample and the reagent are pushed from barrel (53) to waste chamber (59) through a trap chamber (63) of volume from 1 μL to 0.5 μL made in layer L7. The valves (38, 39, 41) are closed and then the valves (37 and 40) are opened. The sealed pre-loaded reagent (54) is pushed to barrel (55) where the mixing is done by triggering the instability at low Reynolds number and by bubbling the air through a diaphragm pump. The above described method can be used to perform an high dilution of order greater than 10,000 of the samples which may be required for cell counting.

The dividing line A-A shows that this cartridge can, simultaneously, be used to divide the cartridge's working into two parts: a) one for RBCs; and b) one for WBCs.

Another aspect of the invention is the use of linear actuators based on lead screw mechanism for opening and closing of the valve by deflecting the soft flexible membrane rather than using pneumatic valve or solenoid valve. The linear actuators should act like a lock to prevent any leakage, in case the pressure from the fluid exceeds the pressure provided by the linear actuators. The possible solution is the lead screw mechanism where the rotary motion is converted to the linear motion, such kind of motion can easily be achieved by a small DC gear motors. The torque of the motor is fixed but the force can be increased by decreasing the pitch of the screw and also the advantage is that once the valve is pressed, it cannot be opened because the linear motion cannot be converted back to the rotary motion. One linear actuator can be utilized for multiple opening and closing of valves, depending on the number of fluidic operation required to for sample preparation.

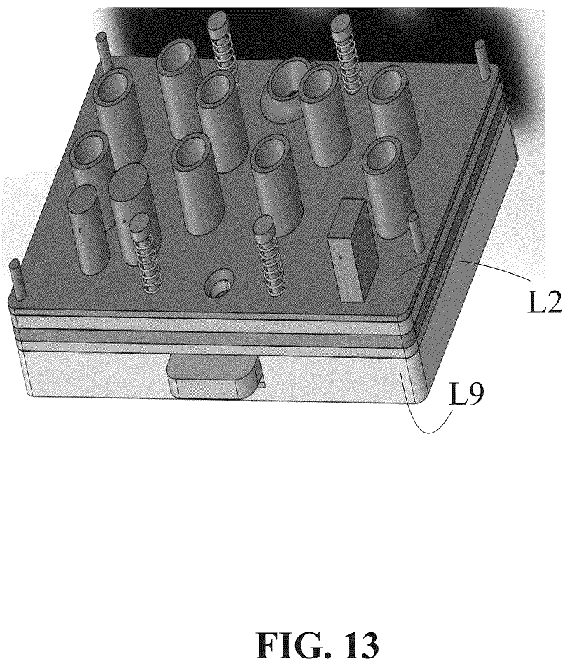

FIG. 13 illustrates layer L2 and layer L9.

In at least an embodiment, the microfluidic cartridge comprises an eighth layer (L8) which is a layer which hosts spring loaded clamps. Essentially, it is a fixture with pillars for closing valves.

According to another embodiment of the invention, spring loaded pillars are provided to closing the side channels permanently after collecting the sample from the inlet port after creating a suction by pressing the soft membrane. The side channels are initially closed by pressing the soft flexible membrane by a spring loaded fixture, having more than four pillars, in order to avoid such errors caused due to jerks/shaky movement of the operator of the device.

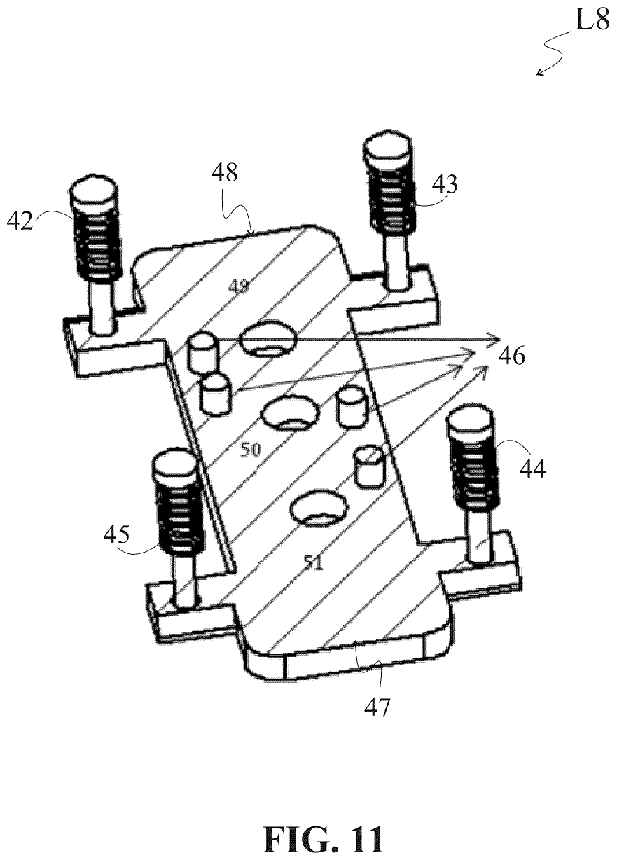

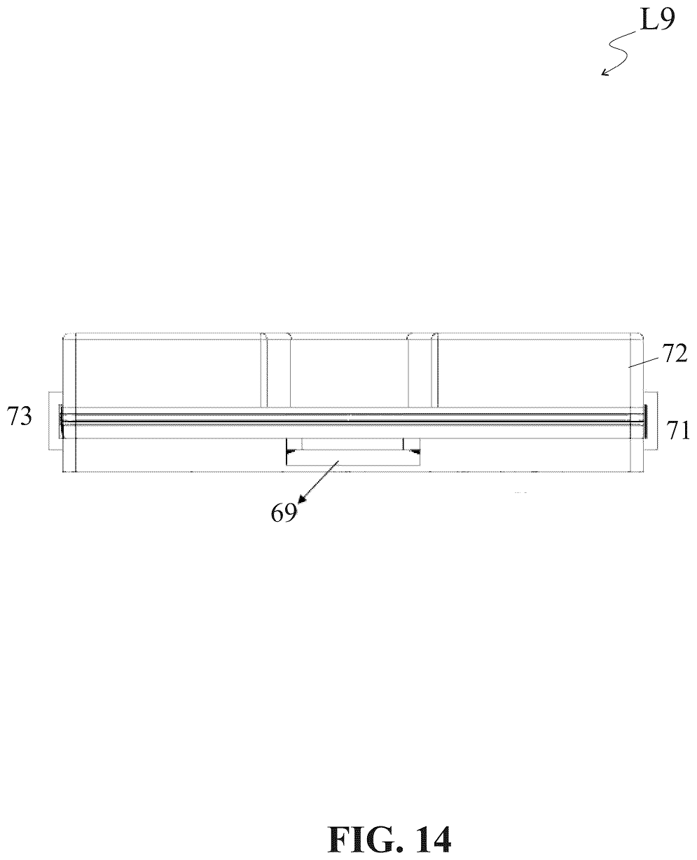

The fixture has four pillars (46) which exerts a pressure on the soft flexible membrane (layer L8) due to four spring loaded rods (42, 43, 44, 45). The rods (42, 43, 44, 45) are either screwed or press fitted. There are also provided three holes (49, 50, 51) where linear actuators exert a pressure on the soft flexible membrane (layer L8) causing it to block the microfluidic channel of layer L5. The spring loaded rods (42, 43, 44, 45) are pass through an upper layer (layer L2) of the microfluidic cartridge through its correspondingly provided holes (6, 7, 8, 9) making the spring(s) to be in a compressed state. The compressed spring(s) exerts a force on the fixture (layer L8) in an upward direction making the valves (30, 31, 32, 33), of layer L5, to be in a closed state. After inserting the cartridge inside the reader, the linear actuators are operated from below the through holes (49, 50, 51) to block the straight channel at position (34, 35, 36) shown in FIG. 7. The pressure is applied in a downward direction at pre-defined position (47 and 48) (reference numeral 47 is the top part of the fixture and reference numeral 48 is the bottom part of the fixture) on the fixture to open the valves (30, 31, 32, 33). The fixture is encased inside the layer L7 shown in FIG. 11. The layer L7 is clamped on the layer L9 though a clamps (71 and 73) (as shown in FIG. 14).

FIG. 11 shows spring loaded fixture of Layer L8.

| Reference | |
|---|---|
| numeral | Part/Component/Element/Member |
| 42 | spring loaded rods |
| 43 | spring loaded rods |
| 44 | spring loaded rods |
| 45 | spring loaded rods |
| 46 | pillars on the fixture to close the side channels |
| 47 | side flange of the fixture |
| 48 | side flange of the fixture |
| 49 | Through-holes made in the fixture |
| 50 | Through-holes made in the fixture |
| 51 | Through-holes made in the fixture |

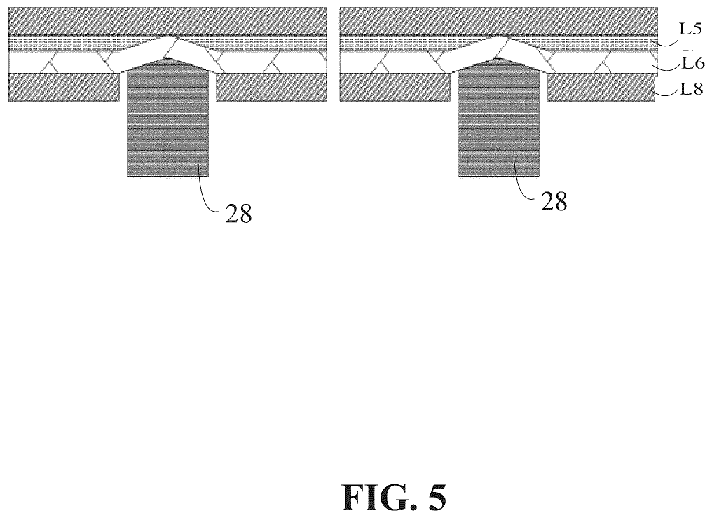

Another aspect of the invention is permanent closing of side channels shown in FIG. 5 by pressing the soft membrane through spring loaded pillars (42, 43, 44, 45) of Layer L8 while collecting sample from the blood inlet port after creating a suction by pressing the soft membrane. Since, the blood is collected before the cartridge is inserted into a reader (of the machine), any jerky movement from the user's hand may cause blood to flow into a side channel. The hydrophobic valve can sustain only few Pascal of burst pressure—so, any kind of shaky movement from a user's hand will cause a significant error in accurate metering of the sample with the reagent. In order to avoid such errors, the side channels are initially closed by pressing the soft flexible membrane by a spring loaded fixture (Layer L8), having more than four pillars (46) of diameter ranging from 2 mm-3 mm. These pillars are used to close corresponding valves (30, 31, 32, 33). The advantage is that it requires more pressure to deflect the fixture in order to move the pillars down to open the valve for metering. The cartridge is then inserted into the reader. Linear actuators are used to press the soft layer (L7) from beneath to block the straight channels shown in FIG. 9 for splitting of fluids into different sections. The figure shows two divisions of samples; however, more than two divisions of samples can be used depending on the number of sample preparation required. The side channels are initially closed with valves (30, 31, 32, 33) and then the soft flexible membrane (L8) is pushed from underneath to close the straight channel using valves (34, 35, 36). There can be more than three valves depending on the number of splitting required in the sample. The initially closed side valves (30, 31, 32, 33) are operated by a fixture (layer L8) placed below the layer L7.

According to an embodiment of the invention, the cartridge is fabricated by stacking multiple layers, for example 8 layers or even more layers in the microfluidic device. These layers are preferably made of different materials, for example hard materials and soft materials.

While considerable emphasis has been placed herein on the particular features of this invention, it will be appreciated that various modifications can be made, and that many changes can be made in the preferred embodiments without departing from the principles of the invention. These and other modifications in the nature of the invention or the preferred embodiments will be apparent to those skilled in the art from the disclosure herein, whereby it is to be distinctly understood that the foregoing descriptive matter is to be interpreted merely as illustrative of the invention and not as a limitation.

1. A disposable cartridge for performing an automatic sample preparation, said cartridge comprising:
at least a barrel housing layer (L2) configured to host extruded barrels for housing liquids (reagents), each barrel being a piston actuated barrel sealed with a frangible seal from its operative bottom side, said barrel housing layer further configured to receive and store a blood sample of a user, which blood sample is to be tested;
at least a puncturing layer (L4) configured to host needles in order to puncture said frangible seal of at least one of said barrels for ejecting liquid out of said barrel, each of said needles corresponding with a barrel, upon receiving a force from its operative bottom side;
at least a liquid flow channel layer (L5) configured with liquid flow channels and valves, built therein, for providing micro-channels for splitting, routing, and metering of said samples with reagents housed in said barrels based on pre-determined opening and closing of sets of valves to determine an appropriate channel path for flow;
at least a soft membrane (L6) configured to work as an interface and is useful for mixing liquids which have a low Renaults number, said soft membrane being configured for in blocking fluidic channels to prevent flow of fluids in channels of choice by closing and opening of said valves; and
at least an actuation layer (L8) configured to provide actuation force for closing or opening of said valves.

2. The disposable cartridge as claimed in claim 1 wherein, said cartridge being configured to provide at least two different sample preparation processes, simultaneously, by splitting the sample between a first set of valves (30, 31) and a second set of valves (32, 33).

3. The disposable cartridge as claimed in claim 1 wherein, said cartridge being configured to provide at least two different sample preparation processes, simultaneously, by splitting the sample between a first set of valves (30, 31) and a second set of valves (32, 33), in that said first set of valves (30, 31) being opened for WBCs enumeration.

4. The disposable cartridge as claimed in claim 1 wherein, said cartridge being configured to provide at least two different sample preparation processes, simultaneously, by splitting the sample between a first set of valves (30, 31) and a second set of valves (32, 33), in that second set of valves (32, 33) being opened for RBCs enumeration and platelet enumeration.

5. The disposable cartridge as claimed in claim 1 wherein, said cartridge comprising at least a top layer for covering said barrels from the side.

6. The disposable cartridge as claimed in claim 1 wherein, said cartridge comprising at least a bottom layer for encasing said layers to protect it from human-intervention.

7. The disposable cartridge as claimed in claim 1 wherein, said cartridge comprising at least a first pressure-sensitive adhesive layer configured to join said barrel housing layer to said puncturing layer.

8. The disposable cartridge as claimed in claim 1 wherein, said cartridge comprising at least a second pressure-sensitive adhesive layer configured to join said soft membrane to said actuation layer.

9. The disposable cartridge as claimed in claim 1 wherein, said actuation layer (L8) comprising:
pillars (46) for closing valves, said pillar extruding from pre-defined positions of base of said actuation layer, each pillar corresponding, in position, with at least a valve of said liquid flow channel layer; and
spring loaded clamps (42, 43, 44, 45) configured to displace said actuation layer (L8) towards or away from said liquid flow channel layer (L5) based through said soft membrane (L6).

10. The disposable cartridge as claimed in claim 1 wherein, said cartridge comprising at least a permanent valve (30, 31, 32, 33) built inside said cartridge which can sustain more than 100 kPa of pressure required for opening a valve for metering of samples with reagents.

11. The disposable cartridge as claimed in claim 1 wherein, said barrel housing layer comprising piston-operated barrels, in that, linear actuators are configured to actuate corresponding pistons for corresponding barrels in order to enable flushing out of fluid (samples) at constant volumetric flow rate.

12. The disposable cartridge as claimed in claim 1 wherein, said barrel housing layer comprising a plurality of mixing barrels (2) for facilitating mixing of a sample as and when required, characterized in that, said mixing barrels (2) having a side vent in order to vent out air.

13. The disposable cartridge as claimed in claim 1 wherein, said barrel housing layer comprising at least a waste collection barrel (3) to collect waste generated after conducting a required test.

14. The disposable cartridge as claimed in claim 1 wherein, said barrel housing layer comprising at least a suction chamber (5) to collect and send blood sample straight into a microfluidic channel of said liquid flow channel layer (L5).

15. The disposable cartridge as claimed in claim 1 wherein, said barrel housing layer comprising at least mixing barrels and pre-loaded reagent barrels, characterized in that, the center of said mixing barrels and said preloaded reagent barrels being arranged on vertices of a regular n-sided polygon to give rotation symmetry of more than four.

16. The disposable cartridge as claimed in claim 1 wherein, said barrel housing layer comprising at least mixing barrels and pre-loaded reagent barrels, characterized in that, the center of said mixing barrels and said preloaded reagent barrels being kept on vertices of a regular pentagon and a hexagon to give 5 degree of rotational symmetry for WBCs sample preparation and 6 degree of rotational symmetry for RBCs sample preparation in order to push and mix the reagents and samples multiple times only with a two stepper motor and two linear actuators.

17. The disposable cartridge as claimed in claim 1 wherein, said barrel housing layer (L2) comprising a blood inlet port (4) which is connected to a suction chamber (5) by a straight microfluidic channel and several microfluidic side channels, characterized in that, said barrel housing layer (L2) comprising a membrane located above said blood inlet port (4) for creating a negative pressure inside said channel.

18. The disposable cartridge as claimed in claim 1 wherein, said cartridge comprising vias (21, 22, 23, 24, 25, 26) made below said soft membrane in order to store blood samples so that sample volume can be increased.
